(19) United States
(12) Patent Application Publication
(10) Pub. No.: US 2008/0045631 A1
(43) Pub. Date: Feb. 21, 2008

(54) Silicone Topcoat With Improved Dirt Repellency and Improved Bondability, With Core-Shell Particle

(75) Inventor: Julia Henn, Mehring (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 11/575,100

(22) PCT Filed: Sep. 8, 2005
(86) PCT No.: PCT/EP05/09676

§ 371 Date: Mar. 12, 2007

(30) Foreign Application Priority Data
Sep. 14, 2004 (DE) 10 2004 044 418.8

(51) Int. Cl. C08L 83/10; C08L 83/04

(52) U.S. Cl. 523/201

(57) ABSTRACT

Topcoats for silicone elastomers contain at least one organopolysiloxane resin, a silane, and core/shell particles, and exhibit reduced coefficients of friction and dirt repellency while being strongly bonded to the susbstrate.

The invention relates to a composition and also to shaped articles, sheetlike structures or elastomers.

EP 718 355 A discloses compositions comprising polyorganosiloxane components which even on their filing date had improved dirt repellency in relation to the then-known state of the art; however, the bondability of coatings comprising this composition to silicone substrate is poor.

It is an object of the invention to improve on the known state of the art, and in particular to improve further the dirt repellency and the bondability.

The invention provides a composition preparable using

polymer components (1)

(A1) polyorganosiloxanes comprising units (T units) of the formula (R₁Si—O_{3/2}) and optionally units (M units) of the formula (R₃Si—O_{1/2})

and/or

(A2) polyorganosiloxanes comprising units (Q units) of the formula (Si—O_{4/2}) and optionally units (M units) of the formula (R₃Si—O_{1/2})

in which

R, identical or different at each occurrence, denotes unhalogenated or halogenated hydrocarbon radicals having 1-18 carbon atoms per radical or denotes OR¹ where R¹ can be identical or different at each occurrence and denotes hydrogen or a monovalent,

unsubstituted or substituted hydrocarbon radical having 1-8 carbon atom(s),

with the proviso that per molecule there are 0.01% to 3.0% by weight of Si-bonded radicals OR¹,

and also, optionally, one or more polymer components selected from the group consisting of:

(B) vinyl chloride-hydroxypropyl acrylate copolymers

(C) vinyl acetate-ethylene copolymer

(D) polyvinyl chloride

(E) polyamide

(F) polyesters

(G) acrylate-polyester copolymers

(H) polyamide-polyester copolymers

(I) vinyl acetate-polyester copolymers

(J) monomeric (meth)acrylates, with the proviso that they are copolymerized with silanes containing Si-bonded (meth)acrylate groups,

(2) silane of the general formula
R³ₓSi(OR²)₄₋ₓ
where R² is a monovalent, unsubstituted or
substituted hydrocarbon radical,
R³ is a monovalent organic radical,
x is 0 or 1,

(3) silicone particles

(4) optionally solvent

(5) optionally catalyst

(6) optionally water.

Examples of radicals R are preferably alkyl radicals, such as the methyl, ethyl, n-propyl, isopropyl, n-butyl, isobutyl, tert-butyl, n-pentyl, isopentyl, neopentyl, and tert-pentyl radical; hexyl radicals, such as the n-hexyl radical; heptyl radicals, such as the n-heptyl radical; octyl radicals, such as the n-octyl radical and isooctyl radicals, such as the 2,2,4-trimethylpentyl radical; nonyl radicals, such as the n-nonyl radical; decyl radicals, such as the n-decyl radical; dodecyl radicals, such as the n-dodecyl radical; octadecyl radicals, such as the n-octadecyl radical; alkenyl radicals, such as the vinyl and the allyl radical; and cycloalkyl radicals, such as cyclopentyl, cyclohexyl, cycloheptyl radicals and methylcyclohexyl radicals.

Examples of substituted radicals R are cyanoalkyl radicals, such as the β-cyanoethyl radical, and halogenated hydrocarbon radicals, examples being haloalkyl radicals, such as the 3,3,3-trifluoro-n-propyl radical, the 2,2,2,2′,2′,2′-hexafluoroisopropyl radical, and the heptafluoroisopropyl radical.

For reasons simply of easier availability, methyl or ethyl radical is preferred as radical R.

Radical R¹ preferably comprises hydrogen atom and unsubstituted or substituted hydrocarbon radicals having 1 to 8 carbon atom(s), particular preference being given to hydrogen and alkyl radicals having 1 to 3 carbon atom(s), especially the methyl, ethyl, and isopropyl radical.

Examples of radicals R¹ are the examples as stated for the radical R and having 1 to 8 carbon atom(s).

Examples of radicals R² are preferably unsubstituted or substituted hydrocarbon radicals having 1-18 carbon atom(s), particular preference being given to alkyl radicals, such as the methyl, ethyl, n-propyl, isopropyl, n-butyl, isobutyl, tert-butyl, n-pentyl, isopentyl, neopentyl, tert-pentyl radical; hexyl radicals, such as the n-hexyl radical and isohexyl radicals; heptyl radicals, such as the n-heptyl radical and isoheptyl radicals; octyl radicals, such as the n-octyl radical and isooctyl radicals, such as the 2,2,4-trimethylpentyl radical. Preference is given to the methyl and ethyl radical. Examples of hydrocarbon radicals R² which may be substituted by an ether oxygen atom are the methoxyethyl, the ethoxyethyl, the methoxy-n-propyl and the methoxyisopropyl radical.

Examples of radicals R³ are preferably unsubstituted or substituted hydrocarbon radicals having 1-18 carbon atom(s), particular preference being given to alkyl radicals, such as the methyl, ethyl, n-propyl, isopropyl, n-butyl, isobutyl, tert-butyl, n-pentyl, isopentyl, neopentyl, tert-pentyl radical; hexyl radicals, such as the n-hexyl radical and isohexyl radicals; heptyl radicals, such as the n-heptyl radical and isoheptyl radicals; octyl radicals, such as the n-octyl radical and isooctyl radicals, such as the 2,2,4-trimethylpentyl radical; nonyl radicals, such as the n-nonyl radical and isononyl radicals; decyl radicals, such as the n-decyl radical and isodecyl radicals; dodecyl radicals, such as the n-dodecyl radical and isododecyl radicals; octadecyl radicals, such as the n-octadecyl radical and isooctadecyl radicals; alkenyl radicals, such as the vinyl and the allyl radical; cycloalkyl radicals, such as cyclopentyl, cyclohexyl, cycloheptyl radicals and methylcyclohexyl radicals; aryl radicals, such as the phenyl, naphthyl, anthryl and phenanthryl radical; alkaryl radicals, such as o-, m-, and p-tolyl radicals, xylyl radicals, ethylphenyl radicals, o-, m-, and p-vinylphenyl radicals, and the nonylphenyl radical; and aralkyl radicals, such as the benzyl radical, the α- and the β-phenylethyl radical; isocyanatoalkyl radicals such as the isocyanatopropyl radical, isocyanatoethyl radical, isocyanatohexyl radical, and isocyanatooctyl radical, the isocyanatopropyl radical being preferred, and (meth)acryloyloxy radicals such as the methacryloyloxypropyl radical, acryloyloxypropyl radical, methacryloyloxyhexyl radical, and acryloyloxyhexyl radical, the methacryloyloxypropyl radical being preferred.

Examples of halogenated hydrocarbon radicals R are haloalkyl radicals, such as the 3-chloro-n-propyl radical, the 3,3,3-trifluoro-n-propyl radical, the 2,2,2,2′,2′,2′-hexafluoroisopropyl radical, the hepta-fluoroisopropyl radical, and haloaryl radicals, such as the o-, m-, and p-chlorophenyl radical.

In the polyorganosiloxanes (A1) the ratio of M units to T units is 0 to 1.8:1, preferably 0.1 to 1.2:1 and more preferably 0.3 to 0.8:1, and in the polyorganosiloxanes (A2) the ratio of M units to Q units is 0.00 to 2.7:1, preferably 0.01 to 2.1:1, more preferably 0.1 to 1.8:1.

The polyorganosiloxanes of the invention form a polymer composed of 2-500, preferably 4-300, monomer units.

The polymer components (A1) and (A2) can be used alone or in each case as mixtures or reaction products of the organosiloxane units. Preference is given to polymer components, such as resin solution K or resin solution K 0118 from Wacker-Chemie GmbH. These resins may preferably be in solution in solvents, such as toluene, xylene, acetone, ethyl acetate, and ethanol. The solvents are used in amounts of preferably 10% to 98% by weight, preferably 30% to 98% by weight, based in each case on the total weight of the polymer components.

The polymer components (A1) and (A2) can be used alone or as mixtures in a ratio of 1:20 to 20:1, preferably 1:10 to 10:1.

Besides the polymer components (A1) and (A2) it is also possible as polymer components (B) to use vinyl chloride-hydroxypropyl acrylate copolymers. Products of this kind are offered commercially by Vinnolit GmbH under the name Vinnolit E 15/40 A. Or (C) copolymers of vinyl acetate and ethylene can likewise be employed as polymer components. Using methods which are known in the literature, both monomers can be used to prepare copolymers in any desired ratio.

As further polymer components it is possible to use (D) polyvinyl chloride, (E) polyamide, (F) polyesters, (G) acrylate-polyester copolymers, (H) polyamide-polyester copolymers or (I) vinyl acetate-polyester copolymers, or (J) monomeric (meth)acrylates, such as methyl methacrylate or butyl methacrylate, which are polymerized in the reaction mixture. Preference is given to polymer components (A1), (A2), (B), and (C), particular preference to the polymer components (A1) and (A2).

The polymer components are present in amounts of 2%-70% by weight in the compositions of the invention. A preferred amount is 5%-50% by weight, a more preferred amount 10%-40% by weight.

Preferred examples of silanes (2) are methacryloyloxy-propyltrimethoxysilane (trade name Silan GF 31-Wacker-Chemie GmbH),

methyltriethoxysilane (trade name Silan M1-Triethoxy-Wacker-Chemie GmbH),

vinyltriethoxysilane (trade name Silan GF 56-Wacker-Chemie GmbH),

tetraethoxysilane (trade name TES 28-Wacker-Chemie GmbH),

mixtures of low molecular mass hydrolysis products of tetraethoxysilane (trade name TES 40-Wacker-Chemie GmbH),

methyltrimethoxysilane (trade name M1-Trimethoxy-Wacker-Chemie GmbH), and

isocyanatopropyltrimethoxysilane (trade name Silan Y 9030 UCC).

The silanes are present in amounts of 0.1%-20% by weight, preferably of 0.5%-10% by weight.

The polymer components are used with the silanes (2) or mixtures thereof in a ratio of 100:1 to 100:30, more preferably 100:2 to 100:20.

The compositions are preferably prepared in organic solvents, such as tetrahydrofuran, toluene, acetone, naphtha, petroleum spirit, methyl ethyl ketone, xylene, butyl alcohol, ethyl acetate, isopropyl acetate or isopropanol.

Organic solvents are present in amounts of 10% to 90% by weight, preference being given to 30%-85% by weight.

The compositions are mixed where appropriate with condensation catalysts, such as preferably organic tin compounds or organic zirconium compounds such as preferably zirconium butoxide, dibutyltin dilaurate, dibutyltin oxide, dioctyltin dilaurate or dibutyltin diacetate.

Among these condensation catalysts preference is given to dibutyltin dilaurate, dibutyltin acetate, and zirconium butoxide.

The condensation catalysts are present in amounts between 0%-10% by weight. Preference is given to amounts of 0%-5% by weight, particular preference to amounts of 0%-2% by weight.

A preferred source of free radicals, which are used preferably in connection with the polymer component (J), is peroxides, especially organic peroxides. Examples of such organic peroxides are peroxyketal, e.g., 1,1-bis(tert-butylperoxy)-3,3,5-trimethylcyclo-hexane, 2,2-bis(tert-butylperoxy)butane, and the like, diacyl peroxides, such as acetyl peroxide, for example, isobutyl peroxide, benzoyl peroxide, and the like, dialkyl peroxides, such as di-tert-butyl peroxide, tert-butyl cumyl peroxide, dicumyl peroxide, 2,5-di-methyl-2,5-di(tert-butylperoxy)hexane, tert-butyl perethylhexanoates, and the like, and peresters, such as tert-butyl peroxyisopropyl carbonate, for example. Preference is given to t-butyl perethylhexanoates (trade name Peroxan PO); Interox TBPIN.

Peroxides are used preferably in amounts of 0% to 5% by weight, in particular of 0% to 3% by weight, based in each case on the weight of the compound employed in the process of the invention.

Where appropriate it is also possible to add water in amounts of 0%-20% by weight, preferably 0%-10% by weight.

The compositions are composed either of silicone resins, which are mixed with functional silanes and hydrolyzed in organic solvents, or of organic (co)polymers, which are copolymerized with functional silanes.

(3) The silicone particles are preferably elastomeric particulate copolymers with a core-shell structure composed of a core a) consisting of an organosilicon polymer and an organopolymer shell c) or two shells b) and c), the inner shell b) being composed of an organo-silicon polymer, and the copolymer being composed of

a) 0.05 to 95% by weight, based on the total weight of the copolymer, of a core polymer of the general formula (R⁴₂SiO_{2/2})ₓ.(R⁴SiO_{3/2})_{y}.(SiO_{4/2})_{z} with x=0 to 99.5 mol %, y=0.5 to 100 mol %, z=0 to 50 mol %,

b) 0% to 94.5% by weight, based on the total weight of the copolymer, of a polydialkylsiloxane shell composed of (R⁴₂SiO_{2/2}) units, and

c) 5% to 95% by weight, based on the total weight of the copolymer, of a shell composed of organopolymer of monoolefinically unsaturated monomers,

R⁴ denoting identical or different monovalent alkyl or alkenyl radicals having 1 to 6 C atoms, or denoting aryl radicals or substituted hydrocarbon radicals,

and the particles have a particle size of 10 to 300 nm and a monomodal particle-size distribution with a polydispersity index of not more than σ₂=0.2.

Particulate copolymers consisting of a core a) and a shell c) are preferably composed of:

a) 5% to 95% by weight, more preferably 20% to 80% by weight, based on the total weight of the copolymer, of a core polymer (R⁴₂SiO_{2/2})ₓ.(R⁴SiO_{3/2})_{y}.(SiO_{4/2})_{z} with x=10 to 99.5 mol %, in particular 50 to 99 mol %; y=0.5 to 95 mol %, in particular 1 to 50 mol %; z=0 to 30 mol %, in particular 0 to 20 mol %; and

c) 5% to 95% by weight, more preferably 20% to 80% by weight, based on the total weight of the copolymer, of a shell composed of organopolymer or monoolefinically unsaturated monomers,

R⁴ denoting identical or different monovalent alkyl or alkenyl radicals having 1 to 6 C atoms, or denoting aryl radicals or substituted hydrocarbon radicals.

Particulate copolymers consisting of a core a), an inner shell b), and a shell c) are preferably composed of:

a) 0.05% to 90% by weight, more preferably 0.1% to 35% by weight, based on the total weight of the copolymer, of a core polymer (R⁴SiO_{3/2})_{y}.(SiO_{4/2})_{z} with y=50 to 100 mol % and z=0 to 50 mol %, in particular 0 to 30 mol %,

b) 0.5% to 94.5% by weight, more preferably 35% to 70% by weight, based on the total weight of the copolymer, of a polydialkylsiloxane shell composed of (R⁴₂SiO_{2/2})ₙ units,

c) 5% to 95% by weight, more preferably 30% to 70% by weight, based on the total weight of the copolymer, of a shell composed of organopolymer or monoolefinically unsaturated monomers,

R⁴ denoting identical or different monovalent alkyl or alkenyl radicals having 1 to 6 C atoms, or denoting aryl radicals or substituted hydrocarbon radicals.

Preferably the radicals R are alkyl radicals, such as the methyl, ethyl, n-propyl, isopropyl, n-butyl, sec-butyl, amyl, hexyl radical; alkenyl radicals, such as the vinyl and allyl radical and butenyl radical; aryl radicals, such as the phenyl radical; or substituted hydrocarbon radicals. Examples thereof are halogenated hydrocarbon radicals, such as the chloromethyl, 3-chloropropyl, 3-bromopropyl, 3,3,3-trifluoropropyl, and 5,5,5,4,4,3,3-heptafluoropentyl radical, and also the chlorophenyl radical; mercaptoalkyl radicals, such as the 2-mercaptoethyl and 3-mercaptopropyl radical; cyanoalkyl radicals, such as the 2-cyanoethyl and 3-cyanopropyl radical; aminoalkyl radicals, such as the 3-aminopropyl radical; acyloxyalkyl radicals, such as the 3-acryloyloxypropyl and 3-methacryloyloxypropyl radical; hydroxyalkyl radicals, such as the hydroxy-propyl radical.

With particular preference the radicals are methyl, ethyl, propyl, phenyl, vinyl, 3-methacryloyloxypropyl, and 3-mercaptopropyl, with less than 30 mol % of the radicals in the siloxane polymer being vinyl, 3-methacryloyloxypropyl or 3-mercaptopropyl groups.

The organosilicon shell polymer b) is composed preferably of dialkylsiloxane units (R⁴₂SiO_{2/2}), with R⁴ having the definitions methyl or ethyl.

As monomers for the organic polymer component c), preference is given to acrylic esters or methacrylic esters of aliphatic alcohols having 1 to 10 C atoms, acrylonitrile, styrene, p-methylstyrene, α-methyl-styrene, vinyl acetate, vinyl propionate, maleimide, vinyl chloride, ethylene, butadiene, isoprene, and chloroprene. Particular preference is given to styrene and also acrylic esters and methacrylic esters of aliphatic alcohols having 1 to 4 C atoms, examples being methyl(meth)acrylate, ethyl(meth)acrylate or butyl(meth)acrylate. Both homopolymers and copolymers of the aforementioned monomers are suitable as the organic polymer component.

The finely divided elastomeric graft copolymers have an average particle size (diameter) of 10 to 300 nm, preferably of 30 to 150 nm, as measured with a transmission electron microscope. The particle-size distribution is very uniform; the graft copolymers are present monomodally—that is, the particles possess a maximum in the particle-size distribution and a polydispersity factor σ₂ of not more than 0.2, as measured with the transmission electron microscope.

The core-shell structure is prepared preferably in accordance with EP 492 376 (Wacker Chemie GmbH) and its examples.

The silicone elastomer particles preferably have a size of 80-120 nm and are in methyl isobutyl ketone. Other solvents such as toluene, acetone and ethyl acetate and butyl acetate are possible, but MIBK has proven particularly advantageous.

The invention further provides a process for preparing a composition, the components of the composition being reacted or mixed, where reaction or mixing take place using

polymer components (1)

(A1) polyorganosiloxanes comprising units (T units) of the formula (R₁Si—O_{3/2}) and optionally units (M units) of the formula (R₃Si—O_{1/2})

and/or

(A2) polyorganosiloxanes comprising units (Q units) of the formula (Si—O_{4/2}) and optionally units (M units) of the formula (R₃Si—O_{1/2})

in which

R, identical or different at each occurrence, denotes unhalogenated or halogenated hydrocarbon radicals having 1-18 carbon atoms per radical or denotes OR¹ where R¹ can be identical or different at each occurrence and denotes hydrogen or a monovalent,

unsubstituted or substituted hydrocarbon radical having 1-8 carbon atom(s),

with the proviso that per molecule there are 0.01% to 3.0% by weight of Si-bonded radicals OR¹,

and also, optionally, one or more polymer components selected from the group consisting of:

(B) vinyl chloride-hydroxypropyl acrylate copolymers

(C) vinyl acetate-ethylene copolymer

(D) polyvinyl chloride

(E) polyamide

(F) polyesters

(G) acrylate-polyester copolymers

(H) polyamide-polyester copolymers

(I) vinyl acetate-polyester copolymers

(J) monomeric (meth)acrylates, with the proviso that they are copolymerized with silanes containing Si-bonded (meth)acrylate groups,

(2) silane of the general formula
R³ₓSi(OR²)₄₋ₓ
where R² is a monovalent, unsubstituted or
substituted hydrocarbon radical,
R³ is a monovalent organic radical,
x is 0 or 1,

(3) silicone particles

(4) optionally solvent

(5) optionally catalyst

(6) optionally water.

Examples of R, R¹, R², and R³ are the examples given above for the radicals R, R¹, R², and R³.

The compositions of the invention can be prepared in stirring and mixing units such as are customary in the chemical industry. The units ought to be temperature-controllable in the range from −10° C. to +150° C. Owing to the use of organic solvents, measures to prevent explosion are vital.

The compositions are prepared simply by mixing the individual components together at temperatures which correspond to the surrounding, ambient temperature. It is, however, also possible to carry out reactions, such as polymerization, condensation or reaction at reactive groups. This then requires the reaction events to be controlled thermally. Such processes are carried out between 0° C. and 150° C. Preferred temperatures are between 10° C. and 120° C. For the sake of simplicity the compositions are prepared under standard atmospheric pressure. It is likewise possible, however, for preparation to take place at superatmospheric pressure up to 20 bar or reduced pressure down to 20 mbar.

The invention further provides a shaped article, sheetlike structure or elastomer that is coated with a composition of the invention.

The composition of the invention serves further as a protective coating of elastomeric moldings or as a topcoat for sheetlike structures coated on one or both sides with elastomeric materials. These sheetlike structures can be films or textiles, especially wovens, formed-loop knits, drawn-loop knits or nonwovens made from synthetic fibers, natural fibers or mineral fibers. Examples of such are injection moldings or extruded moldings made of elastomeric materials such as natural rubber, nitrile rubber, butyl rubber or silicone rubber. Textile supports coated with elastomeric materials, such as conveyor belts, compensators, protective clothing, electrical insulating hoses, electrical insulating mats, coated textiles which can be used for textile constructions, such as tents, awnings, and tarpaulins, following inventive treatment with the topcoat of the invention, exhibit scratch-resistant, dirt-repellant surfaces having a reduced friction coefficient with themselves and with other materials, and also good bondability with silicone rubber adhesives.

The topcoat is applied to silicone-coated textile membranes in coats of 3-50 g/m². Ideal coat thicknesses are 5-15 g/m². The topcoat must on the one hand have sufficient adhesion to the basecoat. On the other hand it must be bondable; in other words, a silicone adhesive must have sufficient adhesion to the topcoat. The adhesion of the coats is measured in accordance, for example, with DIN 53 530 and ought to be at least 150 N/5 cm.

The compositions of the invention can be applied by spraying, brushing, knife coating, by roller imprinting, by screen printing, by immersion or by similar techniques.

With customary silicone rubber surfaces they enter into a firm bond. Curing takes place by evaporation of the solvent and subsequent polycondensation. The cure can be accelerated thermally.

The surfaces treated with the topcoats of the invention are dirt-repellant and scratch-resistant and exhibit reduced friction coefficients with respect to themselves and to other materials, such as glass, metal, plastics, wovens, etc. The surfaces normally treated with the topcoats of the invention are surfaces of silicone rubber moldings, including silicone rubber injection moldings, silicone rubber insulating hoses, medical articles, silicone-rubber-coated wovens, nonwovens, felts, films or papers.

Important properties of the base material, such as tensile strength, elongation, elasticity, tear propagation resistance, resistance to heat and cold, and to chemicals or light, are unaffected by the surface treatment.

Advantages of the composition of the invention are that the compositions can also be applied to silicone rubber moldings, injection moldings, insulating hoses, etc. The application is therefore not restricted only to coated wovens. The compositions of the invention are composed not only of pure silicone resins but also of copolymers and silicone fractions. This makes it possible to achieve two or more properties, such as dirt repellency, scratch resistance, and reduced frictional resistance, with only one topcoat. The topcoats do not lead to stiffening of the base material, as is the case with the known methods. This is a substantial advantage particularly in the field of coated textiles.

The silicone topcoat of the invention exhibits improved dirt repellency, a smooth, nonblocking surface, a low coefficient of friction, and very good bondability.

The topcoat can be applied in only one operation. Together with the basecoat application, therefore, only two operations are necessary. In the case of coated wovens, formed-loop knits, drawn-loop knits or felts, commercially customary liquid silicone rubbers can be employed as basecoats. There are known processes which, by addition of adhesion promoters, make it possible in this case to achieve sufficient adhesion without a primer.

Besides the condensation-crosslinking, peroxidically crosslinking binder systems described, the silicone particles can also be incorporated into addition-crosslinking silicone binder systems.

### EXAMPLES

### Example 1

Preparation of the Graft Base:

3800 g of water and 19 g (1.9% by weight based on Si compounds) of dodecylbenzenesulfonic acid were heated to 85° C. A mixture of 855 g (2.9 mol, 74 mol %) of octa-methylcyclotetrasiloxane, 97 g (0.7 mol, 18 mol %) of methyltrimethoxysiloxane and 66 g (0.3 mol, 8 mol %) of methacryloyloxypropyltrimethoxysilane was metered in and the mixture was stirred at 85° C. for 4 hours. After around 400 g of distillate had been taken off, a dispersion was obtained which had a solids content of 21% by weight and a particle size of 111 nm.

Grafting:

13 050 g of the dispersion were rendered inert with nitrogen in a 15 l reactor and adjusted to a pH of 4. 90 g of methyl methacrylate were metered in and the polymerization was initiated by adding 5.2 g (0.6% by weight based on monomer) of K₂S₂O₈ and 18 g (2.1% by weight based on monomer) of NaHSO₃ (37% by weight in water). Over the course of an hour a further 780 g of methyl methacrylate were metered in, followed by heating to 65° C. and polymerization to completion within 3 hours. The result was a latex with 24% by weight of polymethyl methacrylate in the graft copolymer, having a solids content of 26.7% by weight, a particle size of 127 nm, and a polydispersity index of σ₂=0.02.

### Example 2

Preparation of the Graft Base:

4035 g of water and 8 g (1.8% by weight based on Si compounds) of dodecylbenzenesulfonic acid were heated to 80° C. Over the course of 30 minutes 145 g (0.7 mol, 39 mol %) of phenyltrimethoxysilane and subsequently, over the course of 2 hours, 310 g (1.1 mol, 61 mol %) of octamethylcyclotetrasiloxane were metered in, and the mixture was subsequently stirred at 80° C. for an hour and then distilled until the original volume was regained.

Grafting:

500 g of the hydrosol with a solids content of 9.2% and a particle size of 83 nm were adjusted with sodium carbonate solution to a pH of 5 and saturated with nitrogen. Following the addition of 7 g of freshly washed methyl methacrylate, initiation was carried out by adding 0.09 g (0.13% by weight based on monomer) of K₂S₂O₈ and 0.12 g (0.16% by weight based on monomer) of NaHSO₃ (37% by weight in water), and then a further 62 g of methyl methacrylate were metered in over the course of 30 minutes, followed by heating to 65° C. and polymerization to completion within 3 hours. The result was a latex with 60% by weight of polymethyl methacrylate in the graft copolymer, having a solids content of 23.1% by weight, a particle size of 106 nm, and a polydispersity index of σ₂=0.01.

### Example 3

A stirring unit fitted with a distillation facility—suitable for separating off water discharged azeotropically—is charged with 94 kg of methyl methacrylate, 94 kg of butyl methacrylate and 313 kg of toluene. Water present is removed azeotropically by heating of the mixture at 105° C. When water is no longer discharged from the mixture, it is cooled to 30° C. and 21 kg of Silan GF 31 (commercial product of Wacker-Chemie GmbH) and 2.1 kg of tert-butyl perethyl-hexanoate are added. The reaction mixture is heated to reflux, with a marked reaction ensuing at about 100° C. The mixture is held at reflux for 8 hours and cooled to 30° C. 15.8 kg of n-butanol and 10.5 kg of Silan M1-Trimethoxy (commercial product of Wacker-Chemie GmbH) are mixed in with stirring. After 30 minutes of stirring, 720 kg of isopropanol and 180 kg of petroleum spirit having a boiling range of 120-140° C. are added. Stirring continues for 30 minutes more. The product is discharged through a filter.

This gives a clear, colorless solution having a viscosity of 8 mPa·s and a solids content of 14% by weight.

Subsequently 239 kg of silicone elastomer particles in organic solvents (trade name MIBK 444206 of Wacker Chemie GmbH) are added. After a further 2 h of stirring at ambient temperature, the product is discharged into appropriate drums. The clear, colorless liquid exhibits a viscosity of 13 mm²/s and a solids content of 22%.

### Example 4

A unit fitted with a dissolver disk is charged with 47.8 kg of petroleum spirit (boiling range 140-150° C.), 102.6 kg of methyl ethyl ketone, 236.2 kg of xylene, 9.9 kg of n-butanol and 60 kg of tetrahydrofuran and in this solvent mixture 52 kg of Vinnol E 15/40 A (commercial product of Wacker-Chemie GmbH) are dissolved with vigorous mixing.

0.5 kg of isocyanatopropyltriethoxysilane is added and the mixture is boiled at reflux (about 64° C.) for one hour. It is cooled to 30° C. and 50 kg of tetrahydrofuran, 350 kg of toluene and 1000 kg of acetone are added. Intensive mixing takes place for 30 minutes. The clear, colorless product has a viscosity of 11 mPa·s and a solids content of about 2.8% by weight.

Subsequently 239 kg of silicone elastomer particles in organic solvents (trade name MIBK 444206 of Wacker Chemie GmbH) are added. After a further 2 h of stirring at ambient temperature the product is discharged into appropriate drums. The clear, colorless liquid exhibits a viscosity of 13 mm²/s and a solids content of 22%.

### Example 5

A stirrer mechanism with top-mounted distillation unit is charged with 700 kg of a methylsilicone resin in toluene solution (sales designation silicone resin solution K toluene (sales product of Wacker Chemie GmbH) and 200 kg of silicone resin solution K0118 (sales product of Wacker Chemie GmbH), and these components are mixed. With continual stirring, 324 kg of toluene are distilled off under atmospheric pressure by heating.

The unit plus contents is cooled to room temperature and 108 kg of methyltriethoxysilane (trade name M1-Triethoxysilane of Wacker Chemie GmbH), 54 kg of tetraethoxysilane (trade name TES28 of Wacker Chemie GmbH), 54 kg of vinyltriethoxysilane (trade name Geniosil GF56 of Wacker Chemie GmbH) and 5 kg of zirconium butoxide are added in the stated order with stirring.

Stirring is carried out at ambient temperature for 1 h and then 900 kg of acetone and 44 kg of water are added with stirring, and the mixture is stirred for 1 h. Thereafter 239 kg of silicone elastomer particles in organic solvents (trade name MIBK 444206 of Wacker Chemie GmbH) are added. After a further 2 h of stirring at ambient temperature the product is dispensed into appropriate drums. The clear, colorless liquid exhibits a viscosity of 13 mm²/s and a solids content of 22%.

### Example a

The topcoat of the invention is blended with 5% by weight of hydrodimethylpolysiloxane (trade name Vernetzer W [crosslinker] of Wacker Chemie GmbH) and applied by the knife coating method to a glass woven with a double-sided silicone rubber coating of Elastosil R 401/40 (trade name of Wacker Chemie GmbH). The total weight of the coated woven is 240 g/m². Curing the topcoat at 180° C. in 2 minutes gives a topcoat coatweight of 10 g/m².

The membrane without topcoat has a dirt repellency of 5-5-6. On bonding with a silicone adhesive tape, adhesion values of 217 N/5 cm are produced. With state-of-the-art topcoats, dirt repellencies of between 4-4-3 and 2-3-2 are achieved, and adhesion values of between 0 and 106 N/5 cm. The membrane with the topcoat of the invention has a dirt repellency of 2-2-1 and adhesion values of 233 N/5 cm. The dirt pickup results and also the adhesion values are also lowered only slightly by outdoor weathering for 6 months.

The enlarged surface area in conjunction with effective incorporation into the matrix produces good bondability.

| | | | | Adhesion (N/5 cm) |
|---|---|---|---|---|
| | | | | with silicone |
| | A | B | C | adhesive tape |
| silicone-coated membrane | 5 | 5 | 6 | 217 |
| without topcoat | | | | |
| topcoat of EP 718 355 | 3 | 3 | 3 | 106 |
| commercially available | 4 | 4 | 3 | 10 |
| silicone topcoat A | | | | |
| commercially available | 2 | 3 | 2 | 0 |
| silicone topcoat B | | | | |
| inventive topcoat | 2 | 2 | 1 | 233 |
| example 5 | | | | |

The results of measurement show that the topcoat of the invention has a good dirt repellency and also good cleaning performance. The adhesion values in the bonding test are markedly higher than the required value.

### Example b

A polyester woven with a base weight of 100 g/m² is provided on both sides with a silicone coating comprising liquid silicone rubber (coatweight 100 g/m). The coated woven without topcoat exhibits dirt pickup scores of 5-4-4. The coated woven with topcoat exhibits dirt pickup scores of 3-3-2. The improvement in dirt pickup behavior is retained to a marked extent even after 5 laundering cycles at 60° C.

### Example c

A nylon woven coated with 30 g/m² Elastosil LR 6250F (trade name of Wacker Chemie GmbH) is coated with the topcoat of the invention. The topcoat coatweight is 5 g/m².

In order to measure the coefficient of friction, two samples are placed in each case coating to coating. The coefficient of friction is measured in accordance with DIN 53375.

The topcoat of the invention improves the static and kinetic friction coefficient. The scrub test of DIN ISO 5981 shows that the abrasion resistance of the coating is not adversely affected.

| | Friction | Friction | |
|---|---|---|---|
| | coefficient | coefficient | |
| | kinetic | static | Scrub |
| coated nylon woven | 0.35 | 0.42 | >1000 |
| coated nylon woven + topcoat | 0.27 | 0.32 | >1000 |

Test Methods for Testing the Dirt Repellency

There is no generally accepted standard for determining the dirt repellency of silicone-coated membranes. Therefore an internal company test method has been developed. Carbon black powder is applied to the membrane at 3 sites (A, B, and C) alongside one another using a paper towel, with 3 circular motions in each case. Circles B and C are then rinsed off with distilled water for 10 s. Circle C is additionally cleaned with a moistened paper towel in 3 circular motions. Circle A shows what quantity of carbon black is taken up by the membrane (dirt pickup). Circle B shows how much carbon black is rinsed off by water (washoff). Circle C shows how much carbon black can be removed by subsequent wet cleaning (cleaning). The dirt pickup is evaluated visually on the basis of a scale from 1 (very good) to 6 (very poor). Hence a classification consisting of 3 figures is obtained. The objective of development was to achieve a rating of 2-3-2 or better.

Test Methods for Testing the Bondability

The bondability is determined by bonding 2 silicone-coated membranes, treated with silicone topcoat, using a silicone adhesive tape (e.g., a tape of Elastosil R 4001/40, trade name of Wacker Chemie GmbH, thickness 0.6 mm) in a heated press at 180° C. in 2 minutes. The adhesion of the adhesive bond is measured by a peel test in accordance with DIN 53 530. The objective of the development was to achieve an overall ply adhesion of 150 N/5 cm or better.

1-6. (canceled)

7. A composition comprising:
a polymer component (1) comprising at least one of (A1) and (A2)
(A1) polyorganosiloxanes comprising T units of the formula (R₁Si—O_{3/2}) and optionally M units of the formula (R₃Si—O_{1/2});
(A2) polyorganosiloxanes comprising Q units of the formula (Si—O_{4/2}) and optionally M units of the formula (R₃Si—O_{1/2})
in which
R each are identical or different, and are unhalogenated or halogenated C₁₋₁₈ hydrocarbon radicals, or are OR¹ where each R¹ is identical or different and is hydrogen or a monovalent,
unsubstituted or substituted C₁₋₁₈ hydrocarbon radical,
with the proviso that per molecule there are 0.01% to 3.0% by weight of Si-bonded radicals OR¹,
optionally, one or more polymer components (B) through (J)
(B) vinyl chloride-hydroxypropyl acrylate copolymers
(C) vinyl acetate-ethylene copolymers
(D) polyvinyl chloride
(E) polyamides
(F) polyesters
(G) acrylate-polyester copolymers
(H) polyamide-polyester copolymers
(I) vinyl acetate-polyester copolymers
(J) monomeric (meth)acrylates, with the proviso that the (meth)acrylates are copolymerized with silanes containing Si-bonded (meth)acrylate groups,
(2) at least one silane of the formula
R³ₓSi(OR²)₄₋ₓ
where R² is a monovalent, unsubstituted or substituted hydrocarbon radical,
R³ is a monovalent organic radical,
x is 0 or 1,
(3) core/shell silicone particles,
(4) optionally, a solvent,
(5) optionally, a catalyst, and
(6) optionally, water.

8. The composition of claim 7, wherein the ratio of M units to T units in the polyorganosiloxanes (A1) is 0 to 1.8:1 and the ratio of M units to Q units in the polyorganosiloxanes (A2) is 0-2.7:1.

9. The composition of claim 7, wherein the silicone particles are elastomeric particulate copolymers with a core-shell structure composed of a core a) consisting of an organosilicon polymer, and an organopolymer shell c) or two shells b) and c), the inner shell b) being composed of an organosilicon polymer, and the copolymer comprising:
a) 0.05 to 95% by weight, based on the total weight of the copolymer, of a core polymer
(R⁴₂SiO_{2/2})ₓ.(R⁴SiO_{3/2})_{y}.(SiO_{4/2})_{z}
with x=0 to 99.5 mol %, y=0.5 to 100 mol %, z=0 to 50 mol %,
b) 0% to 94.5% by weight, based on the total weight of the copolymer, of a polydialkylsiloxane shell comprising (R⁴₂SiO_{2/2}) units, and
c) 5% to 95% by weight, based on the total weight of the copolymer, of a shell composed of organopolymer of monoolefinically unsaturated monomers,
R⁴ being identical or different monovalent C₁₋₆ alkyl or C₂₋₆ alkenyl radicals, an aryl radical or substituted hydrocarbon radical,
the particles having a particle size of 10 to 300 nm and a monomodal particle-size distribution with a polydispersity index of not more than σ₂=0.2.

10. The composition of claim 3, wherein the particulate copolymers comprise:
a) 0.05% to 90% by weight, based on the total weight of the copolymer, of a core polymer (R⁴SiO_{3/2})_{y}.(SiO_{4/2})_{z} with y=50 to 100 mol % and z=0 to 50 mol %,
b) 0.5% to 94.5% by weight, based on the total weight of the copolymer, of a polydialkylsiloxane shell composed of (R⁴₂SiO_{2/2})— units, and
c) 5% to 95% by weight, based on the total weight of the copolymer, of a shell composed of organopolymer of monoolefinically unsaturated monomers.

11. A process for preparing the composition of claim 7, comprising mixing and/or reacting the components of the composition.

12. A coated article, wherein the coating is a coating of claim 7.
